(19) United States
(12) Patent Application Publication
(10) Pub. No.: US 2011/0300918 A1
(43) Pub. Date: Dec. 8, 2011

(54) THREE CARD BLACKJACK

(76) Inventor: Merrill SPARAGO, Los Angeles, CA (US)

(21) Appl. No.: 12/857,532

(22) Filed: Aug. 16, 2010

Related U.S. Application Data
(60) Provisional application No. 61/234,077, filed on Aug. 14, 2009.

(51) Int. Cl. G06F 17/00; A63F 1/00

(52) U.S. Cl. 463/13; 273/303

(57) ABSTRACT

The invention relates to a modified blackjack game between a dealer and at least one player. After placing initial wagers, three cards are dealt to each player and two cards dealt to the dealer. The game design allows players to either retain their initial three cards for play, or divide their cards into separate hands. Dividing cards into separate hands requires additional wagers. Players may use their initial three cards by standing or hitting to reach a hand that is higher than the dealers without exceeding twenty one, players may divide their three cards in any fashion that will provide them with the best opportunity to obtain a hand under the conventional rules of blackjack, players will have the choice to play to thirty, thirty-one, or thirty two, and players will have the option of surrendering their initial wager.

### CLAIM FOR PRIORITY

This application claims the benefit of priority to U.S. Provisional Application No. 61/234,077, filed Aug. 14, 2009, the contents of which are hereby incorporated by reference.

### BACKGROUND OF THE INVENTION

1. Field of the Invention

The present invention relates to a card game. More specifically, the invention relates to a modified version of the traditional casino card game blackjack or twenty-one.

2. Prior Art

Blackjack or twenty-one is a well-known casino card game. Blackjack is played with one or more standard decks of 52 cards between a dealer and one or more players. The object of the game is for a player to accumulate a hand of cards having a point total exceeding that of the dealer, without exceeding twenty-one. For numbered cards, the point value equals the number value. Face cards (kings, queens, and jacks) have a point value of ten. Aces are assigned a point value of either one or eleven as determined by the person holding the hand that included one or more aces. A two-card hand having a total point value of twenty-one is known as blackjack.

Blackjack play is commenced by a player making an initial wager (“the ante”) on the outcome of his or her upcoming hand. Players typically indicate their bet or wager by placing an appropriate number of chips or markers in a designated area of the blackjack table.

After the wagers have been placed, the dealer deals two cards to each player and two to him or herself. The dealer deals one card at a time to each player and then to the dealer before repeating the process with the second card. Each of the players' cards is dealt face up or face down depending on the number of decks being used. The dealer's initial two cards are typically dealt one face down and the other face up.

After the dealer and the players have been dealt an initial hand of two cards, each player in turn elects to receive additional cards (“hit”) or to wait (“stand”). A player may elect to take additional cards until he or she decides to stand or until the total point value of the player's hand exceeds twenty-one, known as “bust.” Once all players have either received their desired number of cards or have busted, the dealer turns over the face-down card. Based on the value of that card, the dealer takes additional cards or stands. Under most rules, a dealer must “stand” if the dealer's hand is equal or greater than seventeen and “hit” if the hand is less than seventeen.

Once the dealer has completed the play, the outcome of the game is determined. A player wins if either the dealer busts (dealer's hand exceeds twenty-one) or the player's hand has a greater point value than the dealer's hand. The winning player is paid at 1:1, i.e. receives an amount equal to the initial wager in addition to recovering the initial wager. If the dealer's hand exceeds that of a player's or if a player busts, the wager is lost. If a dealer and the player have equal hands (known as “tie” or “push”), the wager is returned to the player.

During the game, the players have a chance to increase their initial bet (“up the ante”). In addition, a player may split the hand in two hands each hand being supported by two wagers, each of an amount equal to the original wager. Another option is to “double down”, i.e. double the wager in exchange for an additional card.

Blackjack or twenty-one can be modified in various ways to increase the interest of the players. For example, it is often modified by options of various side wagers or side bets. Side wagers are attractive to players because they are perceived as “hedging” the player's chances. For example, a player may bet on a particular outcome of his or her hand. (U.S. Pat. No. 7,222,854). If the outcome is such that the main game is lost but the value of the hand matches the side bet, the player loses the main bet but collects money on the side bet. A similar bet may be placed on the outcome of the dealer's hand (U.S. Pat. Nos. 6,536,767 and 6,113,102). If the dealer receives a winning hand, but the hand also matches the player's side bet, the player loses the main wager but wins the side bet.

In another version of side betting, the players bet on a particular card, such as the next card being dealt. For example, a player may bet that the next card he or she receives will have a particular value (Canadian Application No. 2,281,350). Alternatively, a player may bet on the dealer's face-up card (U.S. Pat. No. 6,796,898) or a dealer's face-down card (U.S. Pat. No. 5,743,532).

In a more exciting variation, the traditional game can be modified by dealing three cards instead of two cards to the players, dealer, or both. For example, in U.S. Patent Application No. 2007/0228653, the players initially place a blackjack wager and a poker wager. The player is dealt three cards and the player uses the three cards to play the poker hand but selects two of the three cards to play the blackjack hand. After the dealer is dealt two cards, one up and one down as in traditional blackjack, the dealer reveals his or her up-card and the poker wager is paid, using a pay table, based on the rank of the player's three initial cards and the dealer's up-card. The blackjack wager is then played according to the traditional rules of blackjack, based on the player's selected two card blackjack hand.

U.S. Patent Application No. 2007/0262524 describes another variation of a three card blackjack game. According to the rules of the game in this patent application, the player places one ante wager and both the player and the dealer are dealt three cards. Both the player and the dealer choose a best hand comprising of two or three cards of the three cards dealt, and the wager is paid if the best player hand beats the best dealer hand. After choosing the best two or three-card hand, the player has a choice to raise if he places a raise wager and can continue the game. If the dealer's hand does not meet qualifying criteria (a total of 17-21) then the player does not win or lose the ante wager, or in an alternative variation, the player wins both the ante wager and raise wager if the player hand beats the dealer's hand and the player loses both the ante wager and raise wager if the dealer hand beats the player hand. If the dealer's hand meets qualifying criteria, then the player wins both the ante wager and raise wager if the player's hand beats the dealer's hand and the player loses both the ante wager and raise wager if the dealer's hand beats the player's hand.

In the conventional game of blackjack, basic strategy is the fundamental guiding principle in playing blackjack and is an essential aspect in directing the player as to deciding whether they hit or stand. As such, players generally follow some form of basic strategy when playing blackjack.

In the conventional game of blackjack, players make a decision to hit (accept more cards) or stand (refuse any further cards) to reach a total as close to, without exceeding twenty one, and obtaining a hand that has a higher point total than the dealer's hand (i.e. if the player has a hand with a total of twenty and the dealer has a hand with a total of nineteen this would be a win for the player). If the player's hand exceeds twenty one then this would be considered a “busted” hand and the player would lose their wager. Thus basic strategy encourages players not to “bust” when they have higher odds of winning with the cards they have.

In basic strategy, the player uses the dealer's exposed (“up”) card to make their decision as to whether they hit or stand to give them the best chance of beating the dealer.

Basic strategy assumes the dealer's non exposed (“down”) card has a value of ten (ten, jack, queen, king), as ten value cards are statistically the most common cards in a standard 52 card deck of playing cards. It encourages players to hit and risk “busting” if there is a high probability the dealer's hand has a higher point total than the players, or to stand (not to take cards) and avoid busting if the odds of winning are in the player's favor.

For example, if the dealer's “up” card is a ten value card, players expect the dealer has a total of twenty (“down” card equals ten and “up” card equals ten for a total of twenty). In this scenario, the dealer likely has a very “strong” hand (i.e. closest to, without exceeding twenty one), and players will take cards so as to potentially beat a total of twenty. Players will risk taking cards and “busting” as they need to reach the desired total.

Alternatively, if the dealer's “up” card is a six value card, the player assumes the dealer has a total of sixteen. As per the conventional rules of blackjack, the dealer must draw more cards with hands that total less than seventeen giving the dealer a high probability of “busting”. In this scenario, players will play their hand more conservatively and avoid “busting” in hopes that the dealer will “bust” making the player a winner.

What is needed is an exciting modified blackjack game that combines using a side bet based on a three card blackjack hand. The goal of the house is to ensure maximum participation of the players, while keeping the odds in favor of the house. Side wagers generally attract players because they are perceived as an extra chance. Just as side wagers attract players, so does having an additional card with several options on how to proceed based on the initial three cards dealt. For example, the player can select the best two of three cards to play traditional blackjack. Or, the player can play the three-card hand and elect to split a hand of three like cards or double down on any of the first two cards. Because the player must place two bets in order to receive the third card, the stakes are higher but the payout and choices of play are increased. It would be especially beneficial for the house to have a player play two bets instead of one during one play of a game, which nevertheless would be very attractive to players.

### SUMMARY OF THE INVENTION

The invention is a three-card blackjack game in which multiple wagers and side bets may be placed.

Three card twenty-one is a casino game played with six standard 52-card decks of playing cards, shuffled together before play and dealt from a shoe. Each round begins with each player making the mandatory three-card wager, and if desired, an optional side wager. The outcome of the mandatory three card wager will be determined by comparing the player's final hand to the dealer's final hand in accordance with the traditional rules of blackjack, highest total without exceeding twenty one wins. The outcome of the side wager will be determined solely by the total of the initial three cards using standard blackjack rankings. If the total of the first three cards meets a pre-determined criteria then the player will win the side wager. Winning wagers will be paid on a pay table that is separate from the play of the three card hand. Each player in play will be dealt three cards face-up, and the dealer will be dealt two cards, one face-up and one face-down. Once each player has received their first three cards, each player who made the side wager will have their hand checked and settled accordingly.

The dealer then checks his hand for a natural total of 21—an ace and a ten valued card. If the dealer has a natural, he will push any player who also has a natural (either a three-card hand totaling 21 or a three card hand including two aces and a ten valued card), and beat all other player totals. If the dealer does not have a natural, and the player has a three card total of 21, that player wins automatically, and is paid even money unless his 21 consists of an ace and two ten valued cards, in which case he is paid at a preferred rate of 2:1. If the dealer does not have a natural, and the player has two aces and a ten valued card, that player wins automatically, and is paid at a preferred rate of 6:1.

In the event that neither the player nor the dealer has one of their respective natural hands, the player is then faced with one of several choices: (1) Keep the original three-card hand together, and play the had as if it were a blackjack hand consisting of three cards. That is, the player may not double down on this hand, but may hit or stand per the rules of traditional blackjack; (2) Split the three-card hand into a two-card hand and a one-card hand, by placing a pair of wagers on the two-card wager and one-card wager spots. The original three-card wager (first wager) is forfeited; (3) Split the three-card hand into three hands, with one card going to each hand. This option is only available, in the preferred embodiment, when the original hand contains a pair with an exact card rank. It is understood that a player may surrender their hand at any point per the traditional rules of blackjack.

Regardless of the player's choice of play, play continues using the traditional rules of blackjack where the dealer hits soft 17, split eights once, split aces once and getting one additional card on each, double on any two cards, and double after splitting eights, with the exception of a player being dealt a twenty-two. The only pairs a player may split are aces and eights. If a player has a two-card soft 21 from any hand that started with one or two cards, it is not considered a natural. Thus, it only pays even money and only if it beats the dealer's hand. When a player is dealt a three-card total of twenty-two, they may either choose to play out their hand in the standard fashion (by either surrendering or taking one of the splitting options), or place an additional bet and receive one more card. If the player does this, and receives a ten valued card, their three-card wager and the additional wager is paid at even money. If any other card is received, the dealer closes that player's hand, and plays his to completion.

In a second variation of doubling down on a three card total of twenty-two, if the player receives a ten valued card or if the dealer busts, the three-card wager is paid at even money and the additional wager pushes. Otherwise, the player loses both wagers.

In one embodiment of the invention, there is a method of playing a modified blackjack game between a dealer and at least one player using at least one standard deck of playing cards, including a) receiving a first wager from the at least one player; b) dealing first and second cards to the at least one player and the dealer; e) dealing a third card to the at least one player to form an original three card hand; f) revealing the second card dealt to the dealer; g) completing each player's hand by an action selected from at least one of the following: (i) using said three cards to complete the hand according to conventional rules of blackjack; (ii) dividing said three cards into two hands using two of said three cards to complete one hand and one of said three cards to complete the second hand according to conventional rules of blackjack, and receiving a second and third wager, (iii) dividing the cards into three one card hands, and receiving a second and third wager from the at least one player, (iv) playing to thirty two when the original three card hand total twenty two, which represents the highest hand and is paid automatically, (v) winning automatically on predetermined hand totals, and (vi) surrendering the original three card hand, h) completing said dealer's hand according to the conventional rules of blackjack; and i) resolving at least one of said first, second, and third wagers by an action selected from the group consisting of: (i) resolving said first wager when the at least one player elects to complete the three card hand according to conventional rules of blackjack; and (ii) collecting said first wager and resolving said second wager and said third wager according to conventional rules of blackjack if the player divided the said three cards into a two card hand and a one card hand, (iii) resolving said wagers one, two, and three, if the player decided to split the cards into three one card hands, (iv) resolving said wager one against a pay scale if the player opted to play to thirty two or wins automatically based on predetermined hand totals, or (v) forfeiting said wager one and retaining wager's two and three should the player declare his three card hand unplayable and not proceed any further with the hand after receiving the initial three cards.

In another embodiment of the invention, there is a computer readable medium having a program stored thereon, executable by a computer, the program configured to play a modified blackjack game against at least one player using at least one standard deck of playing cards, including a) receiving a first wager from the at least one player; b) dealing first and second cards to the at least one player and the dealer; e) dealing a third card to the at least one player to form an original three card hand; f) revealing the second card dealt to the dealer; g) completing each player's hand by an action selected from at least one of the following: (i) using said three cards to complete the hand according to conventional rules of blackjack; (ii) dividing said three cards into two hands using two of said three cards to complete one hand and one of said three cards to complete the second hand according to conventional rules of blackjack, and receiving a second and third wager, (iii) dividing the cards into three one card hands, and receiving a second and third wager from the at least one player, (iv) playing to thirty two when the original three card hand total twenty two, which represents the highest hand and is paid automatically, (v) winning automatically on predetermined hand totals, and (vi) surrendering the original three card hand, h) completing said dealer's hand according to the conventional rules of blackjack; and i) resolving at least one of said first, second, and third wagers by an action selected from the group consisting of: (i) resolving said first wager when the at least one player elects to complete the three card hand according to conventional rules of blackjack; and (ii) collecting said first wager and resolving said second wager and said third wager according to conventional rules of blackjack if the player divided the said three cards into a two card hand and a one card hand, (iii) resolving said wagers one, two, and three, if the player decided to split the cards into three one card hands, (iv) resolving said wager one against a pay scale if the player opted to play to thirty two or wins automatically based on predetermined hand totals, or (v) forfeiting said wager one and retaining wager's two and three should the player declare his three card hand unplayable and not proceed any further with the hand after receiving the initial three cards.

In one aspect of the invention, an action (iii) may be selected only when an exact pair exists in the original three card hand.

In another aspect of the invention, the predetermined hand totals in action (iv) include the at least one player winning automatically when at least of the following occurs: (a) the original total hand is less than twenty-one, and a sum of the three one card hands totals an amount of three to eleven, (b) the original total hand is greater than twenty-one, and a sum of the three one card hands totals an amount of twenty-two to thirty-two, (c) the original total hand equals twenty one.

In still another aspect of the invention, the at least one player wins automatically when the at least one players hand equals twenty one, thirty, thirty one or thirty two.

In yet another aspect of the invention, the hands equal to twenty one, thirty, thirty one and thirty are paid at different ratios.

In another aspect of the invention, for action (vi) the at least one player may only surrender when the total of the sum of the original three hand cards is greater than 21.

In another aspect of the invention, an action (ii) is completed by dealing additional cards to each hand under the traditional rules of blackjack, and wagers are resolved accordingly.

In still another aspect of the invention, an action (iii) is completed by dealing additional cards to each hand under the traditional rules of blackjack, and wagers are resolved accordingly.

### BRIEF DESCRIPTION OF THE DRAWINGS

These and other features and advantages of the present invention will become more readily appreciated when considered in connection with the following detailed description and appended drawings, wherein:

FIG. 1A is an exemplary flow chart illustrating the sequence of play among one embodiment of the present invention.

FIG. 1B is a flow chart similar to FIG. 1A illustrating another embodiment of the present invention in which an initial three-card hand is broken-down into a two-card hand and a one-card hand.

FIG. 2 is a flow chart similar to FIG. 1B illustrating another embodiment of the present invention in which an initial three-card hand is broken-down into three one-card hands.

FIG. 3A is an exemplary diagram of a round of play according to an exemplary embodiment of the present invention with three players playing against a dealer.

FIG. 3B is an exemplary diagram of a round of play according to an exemplary embodiment of the present invention with a player surrendering to the dealer.

FIG. 4A is an exemplary diagram of a round of play according to an exemplary embodiment of the present invention where four players have an initial three-card hand, the sum of which equals twenty-two.

FIG. 4B is an exemplary diagram of a round of play according to an exemplary embodiment of the present invention where three players playing have an initial three-card hand, the sum of which are equal to or greater than twenty-two.

FIG. 4C is an exemplary diagram of a round of play according to an exemplary embodiment of the present invention where a single player having an initial three card hand with a sum exceeding twenty-two.

FIG. 4D is an exemplary diagram of a round of play according to an exemplary embodiment of the present invention where a single player breaks down his three hand card into three one-hand cards.

FIG. 5 is an exemplary diagram of a round of play according to an exemplary embodiment of the invention where a player has an automatic win.

FIG. 6 shows an exemplary blackjack table layout of the type which may be used in accordance with one or more embodiments of present invention.

FIG. 7 is an enlarged view of the players betting area in accordance with an embodiment of present invention.

### DETAILED DESCRIPTION OF THE INVENTION

The invention is a three-card blackjack game in which multiple wagers and side bets may be placed.

The method of playing a modified blackjack game between a dealer and at least one player using at least one standard deck of playing cards comprises the steps of each player initially placing a first wager to participate in the blackjack game. A first card is dealt to each player face up and a first card is dealt to the dealer face down. A second card is dealt to each player face up, and to the dealer face down, and a third card is dealt to each player only, face up. The dealer then reveals their second card by turning over the face down card.

The current modified blackjack game has several specific strategies based on the variety of options available to obtain winning hands. Players can win with point totals that approach but do not exceed twenty one, and have a higher value than the dealer's point total. Alternatively, players can strive for a total of thirty, thirty-one, or thirty two, and gives the player an automatic win regardless of the point total of the dealer's hand (i.e., player has thirty two and the dealer has twenty is a win for the player). A thirty and thirty-one points total may also be used. It is understood that the may be modified to accommodate the rules.

The game design allows players to either retain their initial three cards and play to twenty one, thirty two (or thirty and thirty-one), or divide their cards into separate hands. Dividing cards into separate hands requires additional wagers two and three.

In the modified blackjack game, the player receives three cards. However, the dealer only initially receives two cards (in an alternative embodiment, the dealer may receive a third card) as in the conventional game of blackjack. This feature preserves the basic strategy of blackjack as described above, directing players in their decisions.

Alternatively, players can try to reach a total of thirty, thirty-one or thirty two, and is considered an automatic win for the player (i.e. the player does not have to beat the dealer as the dealer only plays to a maximum of twenty one). Thus, players may play against the dealer (in striving to beat the dealer while not exceeding twenty one) or play against a pay table based on the components of their hand reaching a total of thirty, thirty-one, or thirty two.

Winning hands can be obtained through several different pathways. 1) Players may use their initial three cards by either standing or hitting as per the conventional rules of blackjack to reach a hand that is higher than the dealers without exceeding twenty one, 2) players may divide their three cards in any fashion that will provide them with the best opportunity to obtain a hand under the conventional rules of blackjack, 3) players will have the choice to play to thirty, thirty-one, or thirty two as per the rules of the modified blackjack game, and 4) players will have the option of surrendering their initial wager (wager one as described below) should they choose not to play their hand.

The three wagers allow players to have the option of playing either the three-card hand, or splitting the three card hand into a two card hand and a one card hand, or into three one card hands under certain scenarios.

The three independent wagers are set as follows: one for the three card hand (henceforth referred to as wager one), one wager to play the two card hand (henceforth referred to as wager two), and one wager to play the one card hand (henceforth referred to as wager three). In the event the player elects to divide their hand into three one card hands (when the rules permit), wager one will refer to the first one card hand, wager two to the second one card hand, and wager three to the third one card hand.

In the scenario where the player opts to break down the cards into a two-card hand and a one-card hand, the player forfeits wager one as the three card hand was not played. A second and third wager that are of equal value to wager one are placed, and the hands are played and resolved as per the conventional rules of blackjack. It is understood that the second and third wagers, in another embodiment may differ from wager one.

In the scenario where the player is permitted under the rules to divide the cards into three one card hands, the player retains wager one and places second and third wagers, each wager representing one of the three hands. Wagers one, two, and three are of equal value and are played and resolved as per the conventional rules of blackjack. It is understood that the second and third wagers, in another embodiment may differ from wager one.

After all cards are dealt to the player and the dealer, each player completes his or her hand according to the conventional rules of blackjack using either all three cards, or splitting the cards into a two card hand, and a one card hand, or three one card hands.

The player can only play the three card hand if the total of the three cards does not exceed twenty one. The exception to this is if the player receives a three card total of twenty two and is opting to go for a total of thirty, thirty-one, or thirty two. Other than this, if the three card total exceeds twenty one then the player must split the cards as per the said options or surrender the hand.

In the event the player uses all three cards to complete their hand, then wager one is in play and resolved as per the conventional rules of blackjack. The wager for the three card hand is resolved as per the conventional rules of blackjack but paid at a bonus ratio recommended odds being 1:1. It is understood the ratio is exemplary only, but could be modified as understood.

In the event the player's three cards exceed a total of twenty one they may either 1) try for a total of thirty, thirty-one or thirty two, or 2) split the cards into a two card hand, and a one card hand; or 3) three one card hands (only if an exact pair exists in the initial three card hand).

For example, if the player is dealt a three card total of twenty three (i.e. a seven value card, and two eight value cards) this would be a losing hand as per the conventional rules of blackjack as the sum of total cards exceeds twenty one. The hand also exceeds the total of twenty two and does not qualify for the option of playing to thirty, thirty-one, or thirty two.

As an example of a potential three-card split, with a player hand of eight, eight, and seven, if the dealer's “up” card is a ten value card then the player would be unlikely to divide these cards into separate hands as they each would represent three losing hands as per the basic strategy of blackjack, whereby it is assumed the dealer has a strong hand with a total of twenty. The probability of reaching twenty or twenty one with an eight or a seven in the player's hand is statistically much less likely to occur if they chose to divide the cards into three one card hands and “hit” to play each hand. Therefore, the player would likely lose more money employing the strategy of splitting the hand into three one card hands, than if they surrendered their three card wager (i.e. wager one).

As per the rules of the modified blackjack game, players with a hand of twenty two can opt to take an additional card to reach a total of thirty, thirty-one, or thirty two, (thirty-two being the highest winning point total in the modified blackjack game). Here, wager one would be in play (as is when the player uses their initial three cards to obtain a hand), and the player would have to make an additional wager equal to wager one (i.e. double down) to receive one additional card in attempting to reach a total of thirty, thirty-one, or thirty two,—. Should the player opt to reach thirty, thirty-one, or thirty two, they would not have to beat the dealer, but would be paid against a pay table for winning hands that equal thirty two. Thus, wager one as well as the double down wager would push if a total of thirty is reached, (i.e. player is dealt an eight) or if a total of thirty-one (i.e. player is dealt a nine) is reached, and will be paid a 1:1 if a total of thirty two is reached. Wager one and the double down wager would otherwise lose for all other cards drawn between an ace and a seven.

The sequence of wagering, as well as resolution of wagers, is demonstrated in accordance with the invention.

Prior to revealing any cards, players must place wagers in the designated spot, and the player is dealt a three card hand on the table. In this example, the player places $5 on said wager one. If the sum of the three cards total value does not exceed twenty one, then wager one is in play and may be resolved using the conventional rules of blackjack.

Thus, by example, if the player is dealt three cards totaling twenty, the player may choose to play all three cards against the dealer's hand. A hand of twenty could be obtained through several card combinations; one being the player receiving a ten value card and two five value cards. In this case the player would be likely to “stand” (not draw any more cards) and the hand is played using the conventional rules of blackjack. The dealer then completes their hand using the standard rules of blackjack. Should the player beat the dealer (i.e. have a hand higher in value without exceeding twenty one) wager one is paid at a suggested ratio of 1:1, giving the player $5 in addition to keeping his $5 placed on wager one.

Alternatively, if under the same wagering scheme, the player is dealt three cards totaling twenty six (two ten value cards and a six value card) the player has exceeded twenty one and must divide the hand into a two card hand and a one card hand, three one card hands (If the two ten valued cards make an exact pair, such as two jacks, or surrender the hand). Wager one is forfeited in the event the two card or one card hand is played and a second and third wager are placed which are of equal value to wager one. If the player opts to play three hands, wager one is retained and wagers two and three are placed for play and again must be of equal value to wager one. The player divides their cards as desired, such as placing the two ten value cards in the two card hand for a total of twenty and the six value card in the one card hand. Alternatively, the player may place each card in separate one card hands. However, the player must be dealt an exact pair to utilize the three-card option. Again, players may employ basic strategy to make their decision once the cards are broken down.

The player then completes each hand as per the conventional rules of blackjack and wagers are paid for all winning bets based on the outcome of the dealer's hand.

Players may also retain the option of splitting their three card hand into a two card hand and a one card hand, three one card hands or surrender, even if the total of their first three cards are under twenty one. Should the player decide to split them into a two card hand and a one card hand, wager one is lost, and wagers two and three would be in play as previously described. Should the player decide to divide the hands into three one card hands, the wager one is retained, and all three wagers are in play.

After the initial three card hands are divided, players may also try for bonuses by “doubling down” (i.e. placing an additional equal wager to receive one card) on any two card hands. Players may, “double down” to receive one extra card when they receive a hand that totals twenty two, to play to thirty two as described previously. In the event they do not opt to double down and play to thirty two their wager would be lost as a total of twenty-two is a busted hand. Players may also split cards in the two or one card hand if they receive a card of equal value and denomination. In this case, the player would have to place an additional equal wager to have this option. Players may have the option of taking insurance as per the conventional rules of blackjack.

Bonus rounds are won independent of the dealer hand except when the dealer has a natural blackjack. For example, dealers will pay bonus hands such as a three card twenty one, thirty one/bonus twenty one (ten, ten, ace) or a three card thirty two (ten, ace, ace) based upon a pay table. Thus, the dealer will check their non exposed card if their exposed card is an ace or a ten valued card as in the traditional rules of blackjack. If the dealer's exposed card is an Ace insurance will be offered and paid as per the traditional rules of blackjack. In the event the dealer has a natural blackjack, all bonus hands will push and all hands other than the specified bonus hands will lose. In the event the dealer does not have a natural blackjack all bonus hands are paid according to the pay table despite the outcome of the dealer's final hand. In the event the player would like to forego receiving their bonus and divide their bonus hand then, wager one will be forfeited, and the player will be required to split their cards into a two card hand and one card hand. In the event the original three card and contains an exact pair wager one would not be forfeited. Wagers two and three, which again are of equal value to wager one would be placed and played in either scenario. For example, if the player were dealt a ten, jack, and an ace for a total of thirty one/bonus twenty one they could accept their payout of 2:1 if the dealer did not have a blackjack. Alternatively, should they choose to divide their hand into a two card and one card hand they would forfeit wager one and need to place wager two and wager three. If the player chose to place the ten and the ace together in the two card hand, this is not considered a blackjack under the conventional rules of blackjack but is considered a twenty one, and the hand must beat the dealer's hand to win the wager at a ratio of 1:1 (i.e. the player has a ten and an ace for twenty one, and the dealer has two ten value cards for twenty, the player would win 1:1 on their two card wager).

A more detailed explanation follows with reference to the drawings. It is understood that the drawings and references thereto are exemplary in nature and do not limit the scope of the invention.

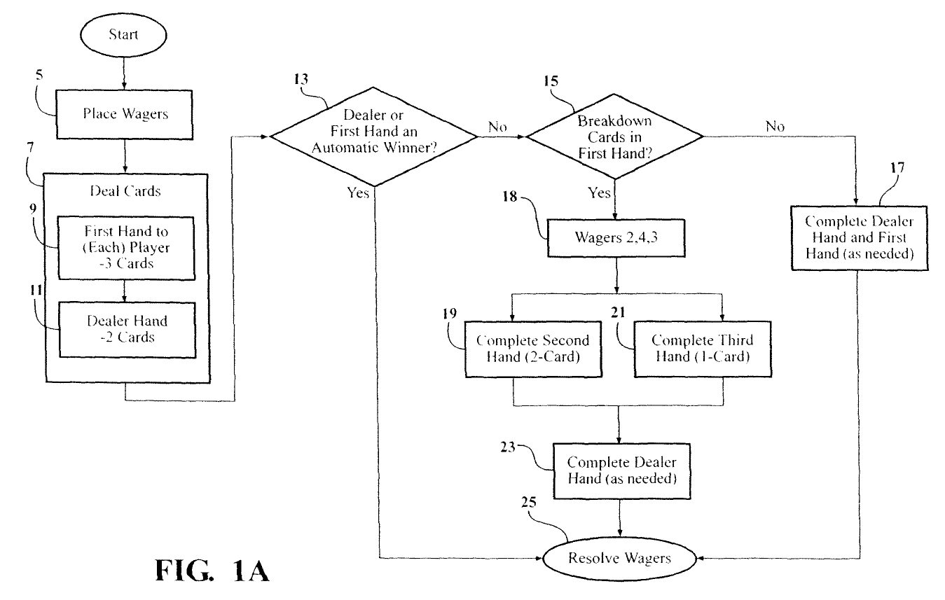

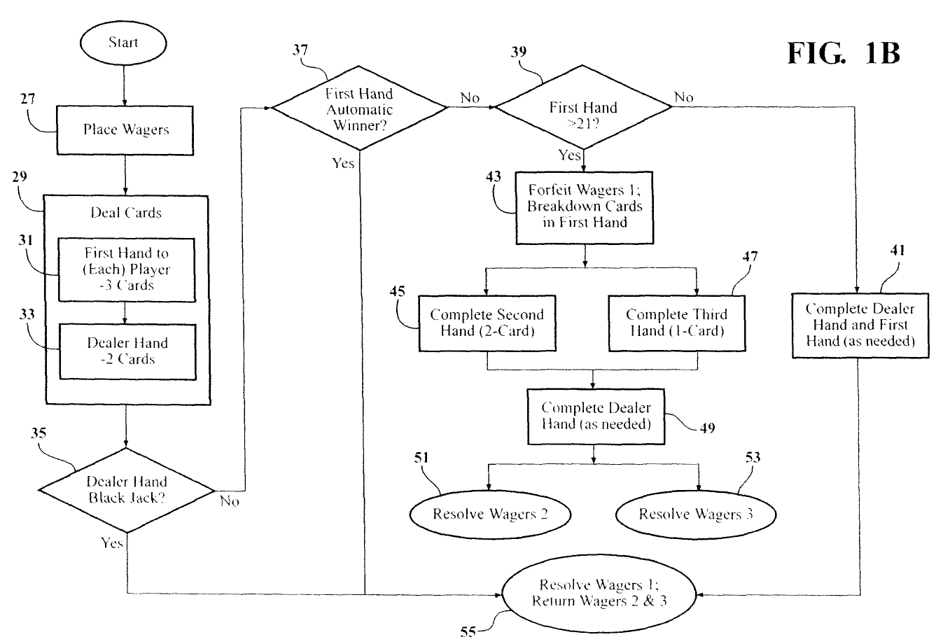

FIG. 1A is an exemplary flow chart illustrating the sequence of play among one embodiment of the present invention. In another version of the modified blackjack game, the game comprises the steps of placing a first wager in step 5 to participate in the modified blackjack game. Each player is dealt a first card face up. The dealer is dealt a first card face down. The player and dealer are dealt the second card face up and a third card is subsequently dealt to each player face up, steps 7, 9 and 11.

At this point in the game, each player can decide if he or she would like to play their hand, split his or her three-card hand into a two-card hand and a one-card hand, or surrender. Three card hands exceeding twenty one must be split into a two card hand and a one card hand or surrendered. If the player hand is an automatic win (step 13) (e.g. hits 21, 32, etc.) the wagers are resolved in step 25. If the player elects to play their initial three card hand, the dealer completes the hand under correctional rules of black jack in step 17. If the player splits the three-card hand, a second and third wager must be placed. Each player then completes his or her hand using the conventional rules of blackjack and steps 19 and 21, followed by the dealer completing his/her hand at step 23. Wages are resolved in step 25.

If the player used all three cards to complete their hand, the first wager can be paid for example at a ratio of 1:1. If the player breaks down their cards into separate hands (e.g. a two card hand and a one card hand), then all active wagers are resolved independently according to conventional rules of blackjack. Players may also choose to use their initial three card hand to play to thirty, thirty one or thirty two as per the preferred embodiment of the game. Bonuses can be paid in accordance with those set forth previously in said preferred embodiment of the modified blackjack game or modified as necessary. Insurance, doubling down, traditional splitting, will be available for pairs of aces and eights, and the value of hands that comprise a ten, ace, and any other card other than a ten and an ace will be played as per the preferred embodiment of the game whereby the ace will be counted as a total of 1.

FIG. 1B is a flow chart similar to FIG. 1A illustrating another embodiment of the present invention in which an initial three-card hand is broken-down into a two-card hand and a one-card hand.

Wager one is placed at step 27 and represents the three card hand dealt to the player. Dealing begins with one card dealt face up to the player and the one card dealt face down to the dealer. The player and dealer are dealt a second card face up, and a third card is subsequently dealt to each player face up (steps 29, 31 and 32).

In the example, if the dealers hand is blackjack (step 35), then wagers are resolved in step 55. Otherwise, automatic win hands at determined in step 37 and resolved at step 55 when there is a winner. If there is no automatic winner in the example provided in FIG. 1B, if a players hand is less than a total of twenty-one, the hand is completed according to the traditional rules of blackjack at step 41. If the players hand exceeds a total of twenty-one (step 39), then wager one is lost, second and third wagers are placed (step 43) and the cards are broken down into a second two-card hand and a third one-card hand. The second and third hands are completed at steps 45 and 47, followed by the completion of the dealer hand in step 49. The second and third wagers are resolved at steps 51 and 53. In another embodiment, automatic wins are paid separately from the modified blackjack game, and players may continue to breakdown cards or play under the conventional rules eve if they have favorably received an automatic win. It is understood that a player may surrender his/her hand per the usual rules of blackjack.

Players may also choose to use their original three card hand to play to thirty, thirty one or thirty two as automatic win embodiment of the game. Automatic wins can be paid out separately (i.e. not depending on action of game), or paid dependent on the continual play of hands.

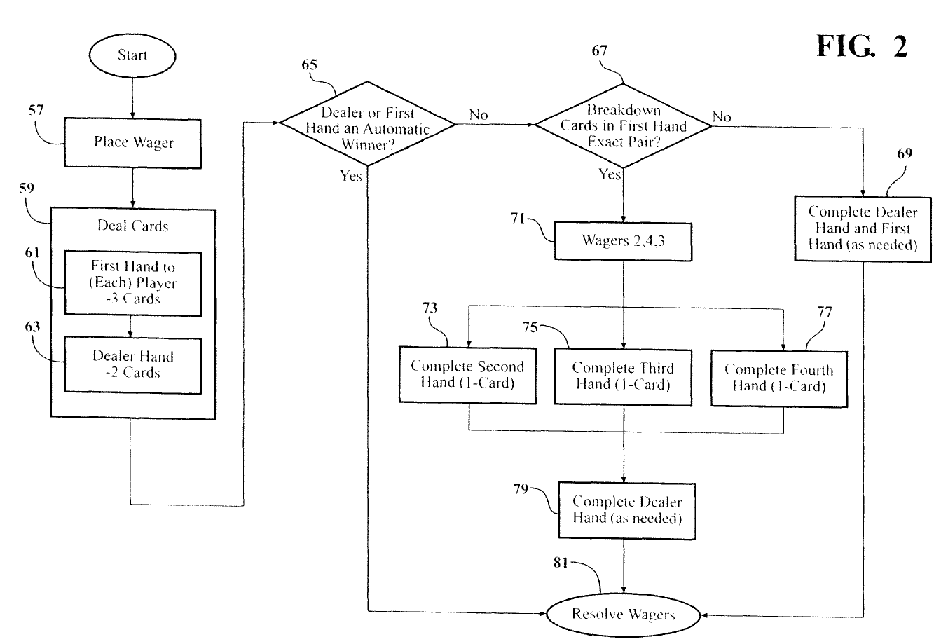

FIG. 2 is a flow chart, similar to FIG. 1, illustrating another embodiment of the present invention in which an initial three-card hand is broken-down into three one-card hands. A three one-card hand breakdown, in the preferred embodiment, is only permitted when an exact pair exists in the players hand (e.g. two cards have the same face value and denomination). The game begins at step 57 with wagers placed by each player. The dealer deals a first and second card to each player and him/herself, followed by a third card to each player in steps 59, 61 and 63. Once the hands are revealed, the dealer determines whether there are any automatic winners for which wagers have been placed, in step 65. If winners are present, wagers are resolved in step 81 and play continues. In the example of FIG. 2, the three-card hands are completed in step 69 under the traditional rules of blackjack, and wagers are resolved in step 81. If, however, any one player has exact pair in their hand, the player may elect to breakdown their cards into three one-card hands at step 67. If the player elects to breakdown their three-card hand into three one-card hands, additional wagers (wagers two and three) are placed at step 71. The three one-card hands are represented and completed in steps 73, 75 and 77, followed by completion of the dealer hand in step 79 under the traditional rules of blackjack. Wagers are resolved in step 81.

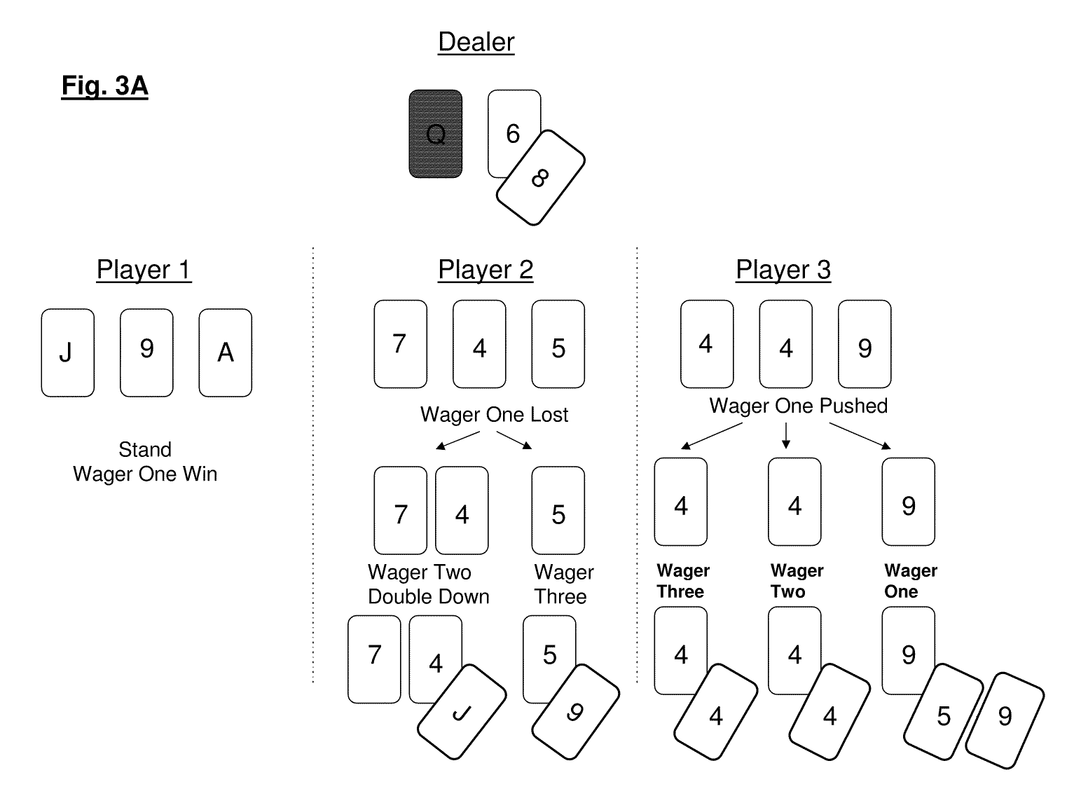

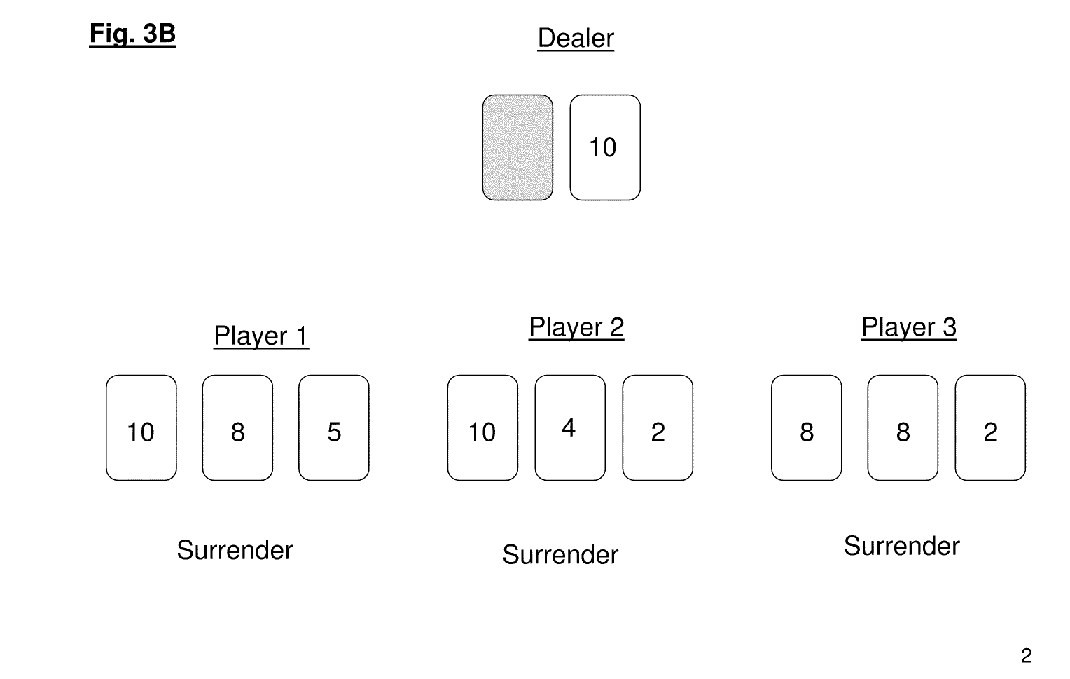

FIG. 3A is an exemplary diagram of a round of play according to an exemplary embodiment of the present invention with three players playing against a dealer. This example depicts three players and a dealer, where player one, player two and player three are dealt a three card hand with a sum of the card values totaling less than twenty-one. In this example, each player places a wager (e.g. $5, $10, etc.) to begin the game. Player one is dealt a jack, nine, and an ace for a total of twenty. Player two is dealt a seven, four, and a five for a total of sixteen, and player three is dealt a four, a four, and a nine for a total of seventeen. The dealer has an exposed six as the up card.

Player one, having a total of twenty, elects to stand. Player two decides to breakdown their hand into a two-card hand and a one-card hand. The two-card hand includes the seven card and the four card for a total of eleven. The five card is placed into the one-card hand. In order to breakdown the cards, the player forfeits the original three card wager and places two additional wagers, namely wager two and wager three. For example, the player forfeits their initial $5 wager and places two additional $5 wagers to play the two-card (wager two) and the one-card hand (wager three). In an alternative embodiment, the additional wagers may be placed up front, at the time of the initial three-card wager. Wagers not played are returned to the player.

During play of the hand, player one has elected to stand, as noted above. Player two decides to double down on their two-card hand of eleven by placing an additional $5 wager (doubling wager two), and receives one card per the traditional rules of blackjack. In the example, the player receives a jack for a total value of twenty-one (blackjack). Play then continues with the players one-card hand which includes a five. In this example, the player hits, receives a nine and stands with a total of fourteen.

Player three, having a pair of fours, opts to play three-one card hands. As explained previously, the three-card breakdown may be played when a player has an exact pair in their hand. To play the hand, the player places two more wagers (wager two and wager three), typically of equal value to the their original three-card wager (wager one). However, the player does not forfeit wager one in this case. Rather, wager one is pushed and used as one of the three one-card hands. For example, the paired cards are broken-down (split) into two one-card hands, and the unpaired card, in this case a nine, is played as the third one-card hand. Play begins in this example at the three card wager space (the first four card), where the player draws a ten for a total of fourteen and stands. Play then moves to the two card hand, which includes the other four from the original three-card pair. The player draws an eight and stands with a total of twelve. Finally, the third one-card hand is played (nine hand). The player draws a five, and elects to draw another card. The second draw shows a nine for a total of twenty-three. The player has therefore busted on this hand, and wager one is lost. The dealer then reveals their hole card, which in this example is a queen, for a total of sixteen. The dealer draws an eight and busts. Winning wagers are paid.

FIG. 3B is an exemplary diagram of a round of play according to an exemplary embodiment of the present invention with a player surrendering to the dealer. Players may also elect to surrender their hand to the dealer for any dealt hand. In this case, three players are dealt a three-card hand after placing respective wagers. Player one is dealt a ten, and eight and five; player two is dealt a ten, four and two; and player three is dealt a pair of eights and a two. The dealer hand shows a ten. Each player surrenders his hand to the dealer, and loses his wager.

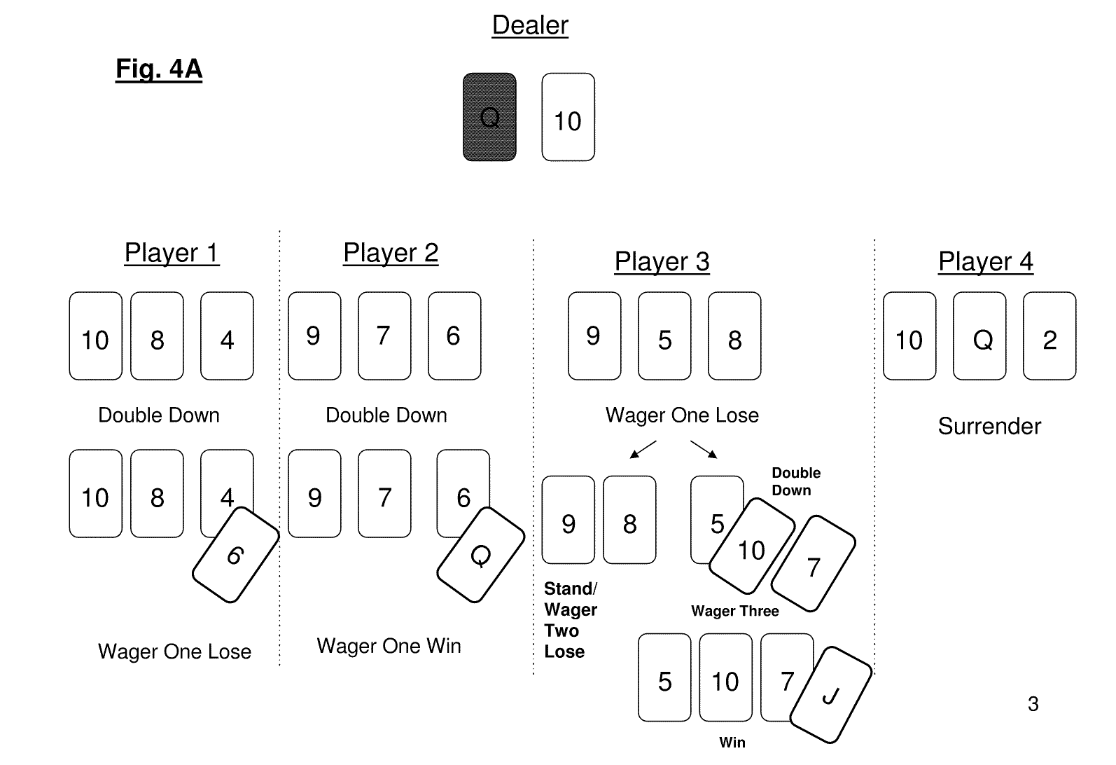

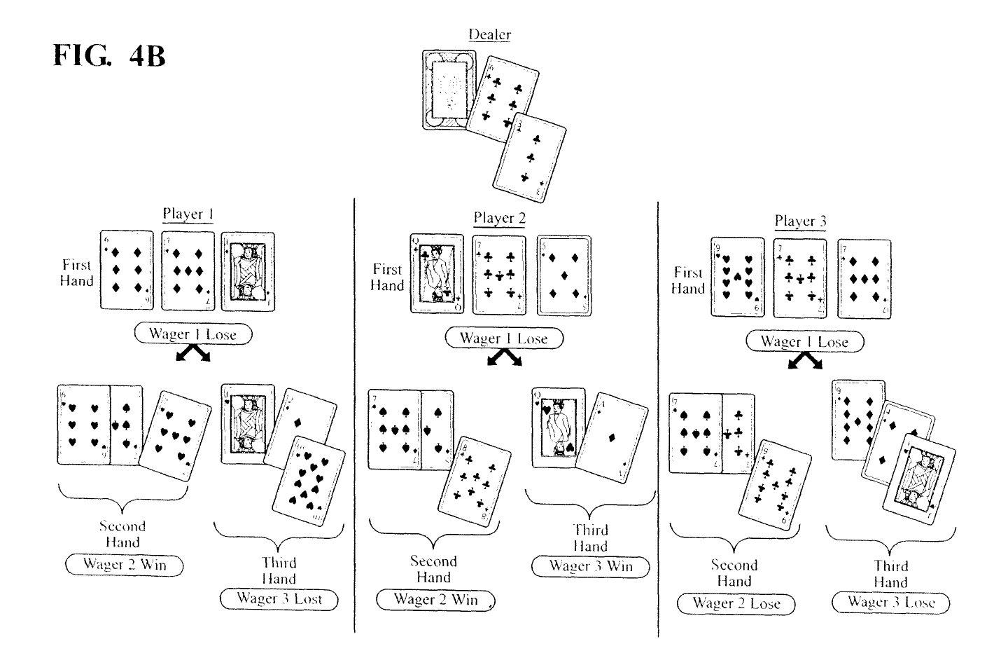

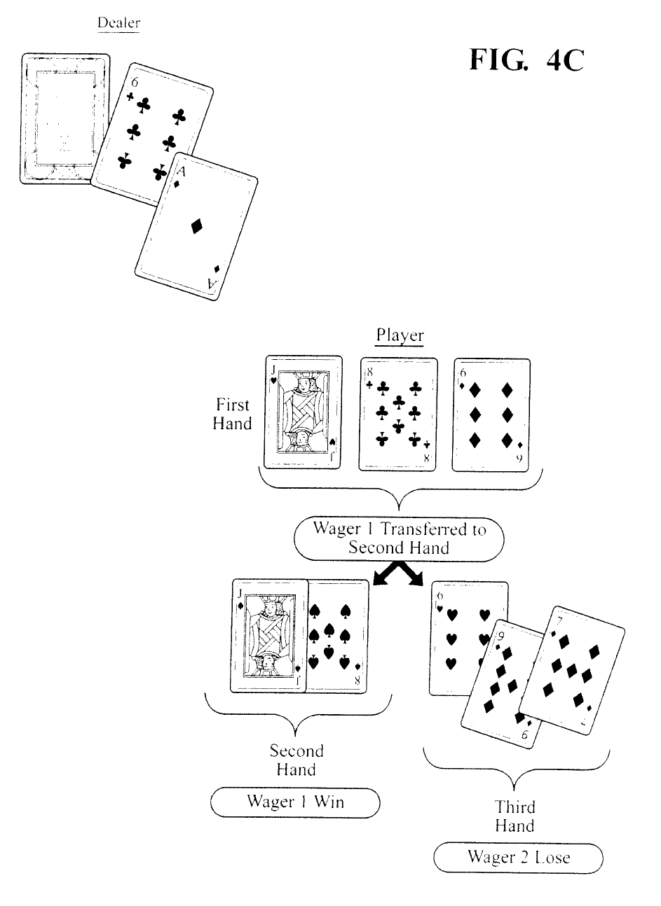

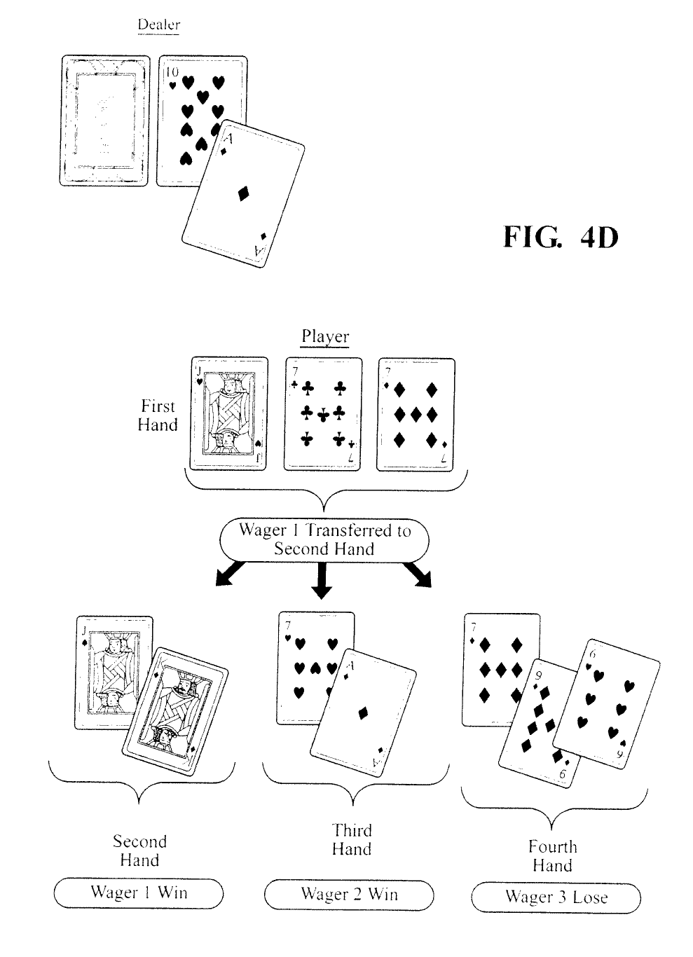

FIG. 4A is an exemplary diagram of a round of play according to an exemplary embodiment of the present invention where four players have an initial three-card hand, the sum of which equals twenty-two. Under the modified rules of three-card blackjack, a player can double down anytime their hand totals twenty-two by placing an additional wager. This double down on twenty-two can occur during any hand played during the game. It is not limited to the first hand dealt. After placing the wager, the player is dealt another card. If the player receives a ten valued card, for a total of thirty-two, the player gets paid even money, in the preferred embodiment. Any other card received results in a loss to the player, and the wager is lost. In an alternative embodiment, players can also play for a total of thirty or thirty-one, with respective payments being applied. Wagers may also be pushed if the dealer busts. It is understood that payments may be modified in any way understood by the skilled artisan and are not limited to the exemplary embodiments herein. It is also understood that the game is not limited to this example, and may be modified to play such that the hand results in any total between twenty-three and thirty-two. It is also understood that a player is not required to double down, and may play the hand according to the traditional rules of blackjack or any modified version thereof.

Each of the four players place a wager (wager one) on the three-card hand dealt by the dealer. In this example, the dealer has a ten exposed. As shown in the figure, player one is dealt a ten, an eight and a four for a total of twenty two. Player two is dealt a nine, a seven and a six for a total of twenty two. Player three is dealt a nine, a five, and an eight for a total of twenty-two. Player four is dealt a ten, a queen, and a two for a total of twenty two. Player one opts to double down, and places an additional wager (doubles wager one), and receives a six for a total of twenty eight. Under the rules of modified blackjack, twenty eight results in an automatic loss to the player, as a total of thirty two was not reached. Wager one for player one is therefore lost. Player two also opts to double down, and receives a queen. As a queen has a face value of ten, player two has a total of thirty two and is paid even money on both wager one and the double down wager. Player three opts to breakdown their hand into a two-card hand of nine and eight for a total of seventeen, and places the five in the one-card hand. Here, since player three is breaking down their cards into a two-card and one-card hand, wager one is lost, and two additional wagers (wager two and wager three) are placed. Player three stands on their seventeen (nine and eight card hand), and hits on their five, receiving a ten. The player draws again, and receives a seven for a total hand of twenty two (a bust under the traditional rules of blackjack). At this point, the player has two options—allow the game to end on the busted hand, forfeiting their wager, or double down again on the twenty two. In this example, the player opts to double down and places an additional wager (the original wager is also retained at this point). The player is dealt a jack, for a total of thirty two, and gets paid even money on both wagers. Player four opts to surrender. His wager and cards are collected by the dealer. The dealer then plays their hand by exposing the hole card, which is a nine for a total of nineteen. Losing wagers are collected.

FIG. 4B is an exemplary diagram of a round of play according to an exemplary embodiment of the present invention where three players playing have an initial three-card hand, the sum of which are equal to or greater than twenty-two. In the example, three players (player one, player two and player three) are dealt a three-card hand after placing the required wager (wager one). Player one is dealt a six, a seven and a jack, and opts to breakdown his hand into a two-card hand (six and seven) and a one-card hand (jack), after placing additional wager two and wager three (wager one is lost). Player one hits on the two-card hand, and receives a seven. He also hits twice on the one-card hand, and receives a two and ten. Player two is dealt a queen, a seven and a five, and opts to breakdown his hand into a two-card hand (seven and five) and a one-card hand (queen). Player two then hits on each hand, receiving an eight on the two-card hand, and an ace on the one-card hand. Similarly, player three is dealt a nine, a seven and a seven, and opts to breakdown his hand into a two-card hand (seven, seven) and one-card hand (nine). Since the player has an exact pair, he could opt to breakdown his hand into three one-card hands, as explained in other embodiments of the invention. In this case, player three hits on the two-card hand, and receives a nine, and hits twice on the one-card hand, receiving a four and a jack. The dealer then completes his hand, receiving a three for a total of nineteen. Wagers are then resolved. Player one wins on the first hand, and loses on the second hand. Player two wins both hands, and player three loses both hands.

FIG. 4C is an exemplary diagram of a round of play according to an exemplary embodiment of the present invention where a single player having an initial three card hand with a sum exceeding 22. In the example, the player place wager one and is dealt a three-card hand that totals twenty four (a bust). At this point, the player decides to breakdown their hand into a two-card hand (jack, eight) and a one-card hand (six). In order to play this breakdown, additional wagers are placed (wager two) along with wager one being transferred to the second hand. In the preferred embodiment, wager one is forfeited and two additional wagers are placed. The player stands on the jack and eight, and hits twice on the six, receiving a nine and then a seven. The dealer is completed his hand and receives and ace, for a total of seventeen. The wagers are resolved, and player one wins the second hand with an eighteen, and loses the third hand with a bust.

FIG. 4D is an exemplary diagram of a round of play according to an exemplary embodiment of the present invention where a single player breaks down. In this exemplary embodiment, the player and dealer are dealt cards (after the player places a wager one) similar to the embodiment detailed above. Here, the player is dealt a three-hand card of jack, seven and seven. Since the player has received an exact pair (seven, seven), he may opt to breakdown his hand into three one-card hands, a jack, a seven and a seven, as illustrated in the figure. In doing so, the player places two additional wagers (wager two and wager three) and transfers wager one. Player one hits on the jack and received a king, hits on the first seven, and receives an ace, and hits twice on the second seven, and receives a nine and six. The dealer completes his hand, and receives an ace, for a total of seventeen. Player one wins on the second hand (twenty), wins on the third hand (eighteen) and loses on the fourth hand (twenty-two). As explained, the player could double down on the fourth hand, which totals twenty-two, but opts not to in this example.

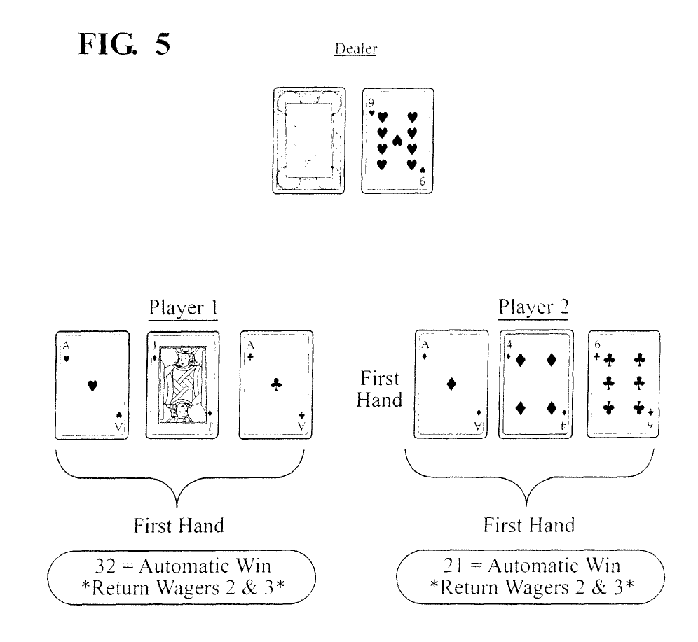

FIG. 5 is an exemplary diagram of a round of play according to an exemplary embodiment of the invention where a player has an automatic win. Player one and player two place an initial wager, and are dealt three cards facing up. The dealer is dealt two cards, one face up and one face down. Player one's hand shows a total of thirty-two, and player two's hand shows a total of twenty-one. As explained in more detail below, each of these hands represents an automatic win for the player, and pays out a bonus accordingly. The dealer's cards, totaling nineteen, is a loss.

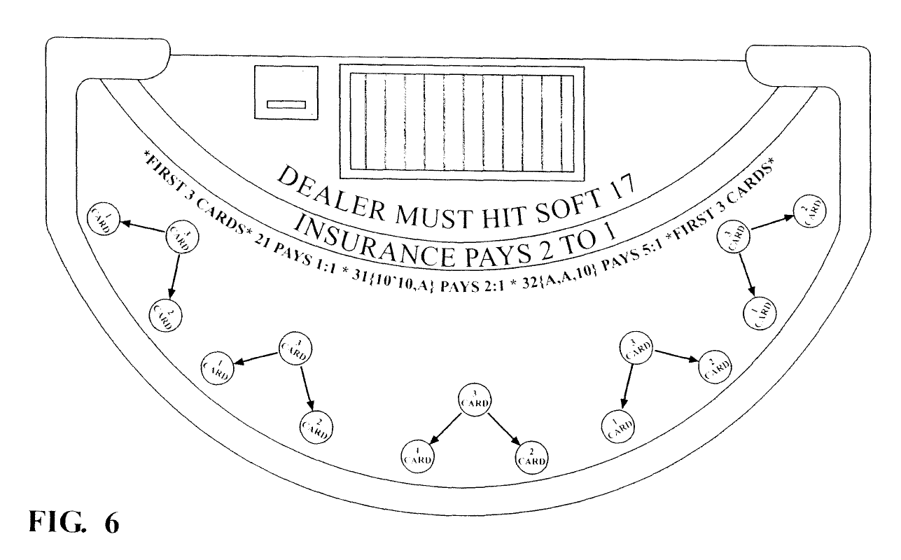

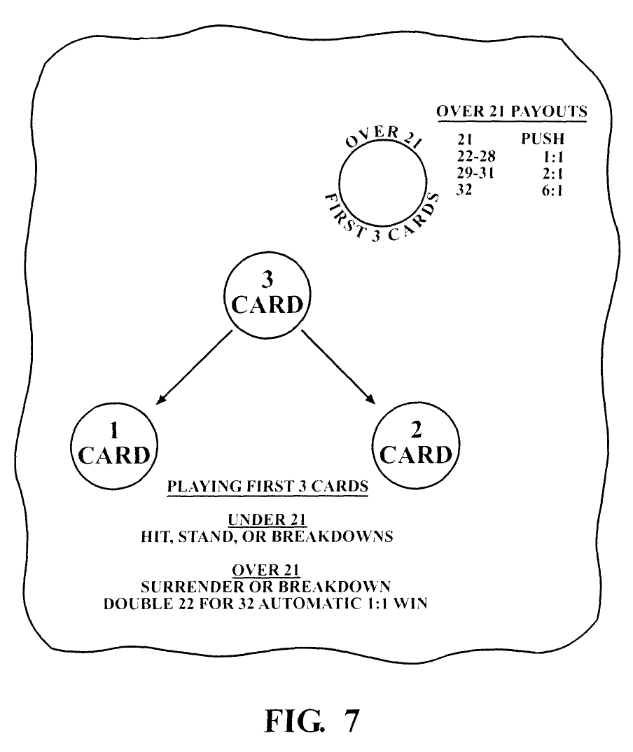

FIG. 6 shows an exemplary blackjack table layout of the type which may be used in accordance with one or more embodiments of present invention. The table layout is exemplary of the table that three-card blackjack may be played on, including spots for wagers. FIG. 7 is an enlarged view of the players betting area illustrated in FIG. 6, in accordance with an embodiment of present invention which includes a side wager in additional to the three card wager. In this instance the side wager pays for three card totals that exceed twenty one according to the illustrated pay table. The table layout and betting areas are exemplary in nature and may be modified to fit the rules of the modified three card blackjack.

In another embodiment of the three-card blackjack, players can retain their initial wager if they breakdown their hand. The wager sits until the dealer plays. If the dealer busts, then the three card wager pushes. Alternatively, the three card wager pushes if the player wins all hands that resulted from the play of their cards after the breakdown. For example, if a player breaks down a ten, ten and nine into a twenty, and a nine, hits the nine and receives a ten (for a total of nineteen), and the dealer has an eighteen, the player wins all of their wagers after the breakdown and their three card wager would push or possibly win even money.

Players may also place a side wager (herein also referred to as the 1-2-3 wager) in which the side wager pays for a specific single card, two card combination or three card combination. The side wager is played with respect to the players initial three card hand, and is resolved (i.e. played and paid) independently of the initial wager (wager one). The side wager is optional and does not necessarily have to be the same amount as the three card wager. To win the side wager, players place the wager before any cards are dealt.

Players win the side wager if: (1) the three card hand includes one specific card that qualifies for the bonus, such as an ace or more specially an ace of a particular suit. Similarly, the single card could be a jack or a jack of a specific suit; (2) the player's hand has a specific combination of two cards in their initial three card hand. For example, the two card combination is a blackjack (i.e. a ten value card and an ace, or more specifically a suited blackjack, whereby the ten valued card and the ace would need to be of the same suit to win the side wager); or (3) the initial three cards reach a specified total using standard blackjack point values. To win the wager, the predetermined totals will range from three to nine and twenty two to thirty two. Essentially, players win if their three card total is under a specified threshold or over a specified threshold, while totals in between would lose. For example, three card totals of less than nine would win, as would three card totals of greater than 22. Totals between nine and twenty would lose. Three card totals of twenty one would push or win depending on house rules. It is understood that these ranges are exemplary and may be modified accordingly.

Winning wagers are paid according to a predetermined pay table. The side wager is played independent of the outcome of the dealers hand, except in the case of a dealer blackjack. In this case, the side wager would either win, push, or lose depending on the payable selected by dealer (house). Each player also has the option of purchasing insurance in the event the side wager loses. Insurance is offered on the side wager per the traditional rules of blackjack and typically pays 2:1 (i.e. in traditional blackjack, if the dealers up card is an ace then the dealer offers players insurance to insure their wager in the event of a dealer blackjack). Players can wager up to half of their initial wager, and if the dealer has a blackjack their insurance wager is paid 2:1.

An example of three-card blackjack with a side wager follows. Four players and a dealer play in the example. Each player makes an initial wager (i.e. the three card wager) and a side wager. Player one is dealt a ten, two, and a seven. Player two is dealt an ace, ace, and a three. Player three is dealt a ten of spades, and an ace of spades, and a seven. Player four is dealt a ten, a queen and a nine. The side wager is resolved for each player in turn before their three card wager is played.

In the above example, player one loses their side wager with a total of nineteen (where it is assumed this total does not fall into the predetermined criteria for winning the wager). The side wager would be collected, and the player would complete the play of their three card hand. After completing their hand the dealer would then move to the next player, again resolving the side wager before playing the three card hand. For the purpose of resolving the side wager aces, will have a point total of one or eleven but will only count as eleven if the player has a total of thirty one (i.e. two ten value cards and an ace) or thirty two (i.e. two aces and a ten value card).

Player two has a total card value of five (ace, ace and three). Since a total of five is in the predetermined winning range, the player will win their side wager based on the predetermined pay table (where it is assumed that five falls into the predetermined criteria for winning the wager). They would then play their three card hand. Player three would also win their side wager, as the original three card hand includes a suited blackjack. Player four would also win their side wager as their hand totals twenty nine (again, assuming this total falls into the predetermined pay table as a win)

Alternative bonus schemes can be developed which include the use of the dealers hand and the players hand. For example, if the player is dealt a three card twenty one, thirty one, or thirty two and the dealer has a blackjack, a bonus would be paid on the side wager. The relative infrequency of the dealer getting a blackjack, while the player also has a bonus hand, makes this scenario ideal for a super bonus or a progressive jackpot. In this scenario, five card poker hands can be formed using the dealers two cards and the players initial three cards, whereby the dealer's hand would always be a blackjack. The game stops whenever the dealer has a blackjack, and the dealer can compare their two card hand in combination with each players three card hand to determine the winner.

In accordance with the alternative bonus, players can win a large bonus on a side wager if they are dealt a twenty one, thirty one or thirty two when the dealer has a natural blackjack. Larger payouts can be offered if the dealers blackjack combined with the players three cards also formed a flush, e.g. a player ten, ace, ace of spades and dealer jack, ace of spades. This can occur because the game can use more than one deck. Additionally, other bonuses can be paid for full houses (e.g. dealer ten, ace and player ten, ten, ace or player ten, ace, ace). Similarly, the bonus hand does not have to be limited to players also having a twenty one, thirty one, or thirty two when the dealer has a blackjack. Bonuses can also be paid for straights, flushes, and royal flushes, for example.

For example, if a player is dealt a ten, jack, and king of different suits, and the dealer has a blackjack consisting of queen, ace, this would constitute an ace high straight and be paid a bonus. Similarly, if the players ten, jack, king and the dealers queen, ace were all hearts, this would be a royal flush. Alternatively, if the player had a three, six, and ten of hearts in their three card hand, and the dealer had a ten and an ace of hearts, this would constitute a flush. Payouts could also be made for other poker hands such as three or four of a kind. For example, a dealer ten, ace and a player ten, ten, four as a three of a kind. Or, a dealer ten, ace with player ten, ten, ten as a four of a kind. The bonus wager again is separate and resolved independently of the main wager.

It is understood that the pay ratios can be predetermined and displayed on a pay table on or near the blackjack table. The pay ratios suggested above are not meant to indicate actual payouts in all instances, and are exemplary in nature.

The present invention holds a special attraction to the players in several ways. First, the side wager of the present invention is perceived as a better chance of winning because the player is given a choice of a combination of three cards and can choose to use these three cards or split them into two or three separate hands, each of which the player can win. Second, the player may surrender their three card hand if the expectation is they will lose more wagers by continuing on in the game. Third, as the player only needs to place one wager to receive three cards, they can limit the amount of money wagered if the receive undesirable cards, but can also increase the amount of money wagered after seeing favorable cards trying to win more on a favorable situation Fourth, the player may use basic strategy to play each hand as the dealer receives only two cards as in the conventional game of blackjack. Fifth, the player may also opt to play to the highest ranked hand of thirty two, again giving the player another option to receive bonus payouts, and providing another level of strategy to the game, not present in traditional blackjack in which twenty one is the highest hand. Sixth, if the player does play to thirty two they do not have to beat the dealer, but instead are paid against a pay table, again introducing another novel concept and strategy to the traditional game of blackjack. Seventh, the player can win more money for bonus three-card hands. Eighth, the game is easily adaptable to a progressive bonus system. The house receives the benefit of receiving three bets, possibly four, instead of one through routine play of the game.

In addition, as is common with other card games, the modified blackjack games of the present invention may be played between at least one player and an automated device. The automated device may be a computer or any other device, mobile or otherwise, capable of playing blackjack. The device may represent one or more additional players and a dealer. Such devices include a display; means of making selection, such as for example, a touch-screen display, a set of keys or a keyboard; means of collecting and dispensing actual or virtual wagers, for example, an opening for depositing and dispensing coins or tokens, or reading a magnetic card; and a data processing unit. Such a device may be programmed to offer the side bet of the present invention as a part of a blackjack game.

The present invention is a modified blackjack game. Traditionally, blackjack is played with a dealer dealing two cards to each player that places an initial wager. The goal of the game is to obtain a hand closer to twenty-one than the dealer without exceeding twenty-one. The modified game of the present invention includes placing a side wagers at the same time the traditional blackjack wager is placed in order to have the option of playing a three card blackjack hand.

Lastly, a table having markings in accordance with traditional rules of blackjack and having markings designating at least two areas for wagers per player and an automated device comprising a display, means for making a selection, and a data processing unit can be provided for playing the modified blackjack games. The automated device can further comprise a means for receiving and dispensing funds, such as a magnetic card reader.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A method of playing a modified blackjack game between a dealer and at least one player using at least one standard deck of playing cards, comprising:
a) receiving a first wager from the at least one player;
b) dealing first and second cards to the at least one player and the dealer;
e) dealing a third card to the at least one player to form an original three card hand;
f) revealing the second card dealt to the dealer;
g) completing each player's hand by an action selected from at least one of the following:
(i) using said three cards to complete the hand according to conventional rules of blackjack;
(ii) dividing said three cards into two hands using two of said three cards to complete one hand and one of said three cards to complete the second hand according to conventional rules of blackjack, and receiving a second and third wager,
(iii) dividing the cards into three one card hands, and receiving a second and third wager from the at least one player,
(iv) playing to thirty two when the original three card hand total twenty two, which represents the highest hand and is paid automatically,
(v) winning automatically on predetermined hand totals, and
(vi) surrendering the original three card hand,
h) completing said dealer's hand according to the conventional rules of blackjack; and
i) resolving at least one of said first, second, and third wagers by an action selected from the group consisting of: (i) resolving said first wager when the at least one player elects to complete the three card hand according to conventional rules of blackjack; and (ii) collecting said first wager and resolving said second wager and said third wager according to conventional rules of blackjack if the player divided the said three cards into a two card hand and a one card hand, (iii) resolving said wagers one, two, and three, if the player decided to split the cards into three one card hands, (iv) resolving said wager one against a pay scale if the player opted to play to thirty two or wins automatically based on predetermined hand totals, or (v) forfeiting said wager one and retaining wager's two and three should the player declare his three card hand unplayable and not proceed any further with the hand after receiving the initial three cards.

2. The method of claim 1, wherein action (iii) may be selected only when an exact pair exists in the original three card hand.

3. The method of claim 1, wherein the predetermined hand totals in action (iv) include the at least one player winning automatically when at least of the following occurs: (a) the original total hand is less than twenty-one, and a sum of the three one card hands totals an amount of three to eleven, (b) the original total hand is greater than twenty-one, and a sum of the three one card hands totals an amount of twenty-two to thirty-two, (c) the original total hand equals twenty one.

4. The method of claim 1, wherein the at least one player wins automatically when the at least one players hand equals twenty one, thirty, thirty one or thirty two.

5. The method of claim 4, wherein the hands equal to twenty one, thirty, thirty one and thirty are paid at different ratios.

6. The method of claim 1, for action (vi) the at least one player may only surrender when the total of the sum of the original three hand cards is greater than 21.

7. The method of claim 1, wherein action (ii) is completed by dealing additional cards to each hand under the traditional rules of blackjack, and wagers are resolved accordingly.

8. The method of claim 1, where action (iii) is completed by dealing additional cards to each hand under the traditional rules of blackjack, and wagers are resolved accordingly.

9. A computer readable medium having a program stored thereon, executable by a computer, the program configured to play a modified blackjack game against at least one player using at least one standard deck of playing cards, comprising:
a) receiving a first wager from the at least one player;
b) dealing first and second cards to the at least one player and the dealer;
e) dealing a third card to the at least one player to form an original three card hand;
f) revealing the second card dealt to the dealer;
g) completing each player's hand by an action selected from at least one of the following:
(i) using said three cards to complete the hand according to conventional rules of blackjack;
(ii) dividing said three cards into two hands using two of said three cards to complete one hand and one of said three cards to complete the second hand according to conventional rules of blackjack, and receiving a second and third wager,
(iii) dividing the cards into three one card hands, and receiving a second and third wager from the at least one player,
(iv) playing to thirty two when the original three card hand total twenty two, which represents the highest hand and is paid automatically,
(v) winning automatically on predetermined hand totals, and
(vi) surrendering the original three card hand,
h) completing said dealer's hand according to the conventional rules of blackjack; and
i) resolving at least one of said first, second, and third wagers by an action selected from the group consisting of: (i) resolving said first wager when the at least one player elects to complete the three card hand according to conventional rules of blackjack; and (ii) collecting said first wager and resolving said second wager and said third wager according to conventional rules of blackjack if the player divided the said three cards into a two card hand and a one card hand, (iii) resolving said wagers one, two, and three, if the player decided to split the cards into three one card hands, (iv) resolving said wager one against a pay scale if the player opted to play to thirty two or wins automatically based on predetermined hand totals, or (v) forfeiting said wager one and retaining wager's two and three should the player declare his three card hand unplayable and not proceed any further with the hand after receiving the initial three cards.

10. The computer readable medium of claim 9, wherein action (iii) may be selected only when an exact pair exists in the original three card hand.

11. The computer readable medium of claim 9, wherein the predetermined hand totals in action (iv) include the at least one player winning automatically when at least of the following occurs: (a) the original total hand is less than twenty-one, and a sum of the three one card hands totals an amount of three to eleven, (b) the original total hand is greater than twenty-one, and a sum of the three one card hands totals an amount of twenty-two to thirty-two, (c) the original total hand equals twenty one.

12. The computer readable medium of claim 9, wherein the at least one player wins automatically when the at least one players hand equals twenty one, thirty, thirty one or thirty two.

13. The computer readable medium of claim 12, wherein the hands equal to twenty one, thirty, thirty one and thirty are paid at different ratios.

14. The computer readable medium of claim 9, for action (vi) the at least one player may only surrender when the total of the sum of the original three hand cards is greater than 21.

15. The method of claim 9, wherein action (ii) is completed by dealing additional cards to each hand under the traditional rules of blackjack, and wagers are resolved accordingly.

16. The method of claim 9, where action (iii) is completed by dealing additional cards to each hand under the traditional rules of blackjack, and wagers are resolved accordingly.
